(19) United States
(12) Patent Application Publication
(10) Pub. No.: US 2011/0096107 A1
(43) Pub. Date: Apr. 28, 2011

(54) COLOR SEQUENTIAL LIQUID CRYSTAL DISPLAY DEVICE AND RELATED DRIVING METHOD

(76) Inventors: Wen-Chih Tai, Hsinchu County (TW); Chi-Chung Tsai, Kinmen County (TW); Kai-Ting Hu, Taichung City (TW); Chi-Neng Mo, Taoyuan County (TW); Kuang-Lang Chen, Taoyuan County (TW)

(21) Appl. No.: 12/693,449

(22) Filed: Jan. 26, 2010

(30) Foreign Application Priority Data
Oct. 28, 2009 (TW) 098136496

(51) Int. Cl. G09G 5/10; G09G 3/36

(52) U.S. Cl. 345/691; 345/88

(57) ABSTRACT

A method for driving a color sequential liquid crystal display device first provides a vertical synchronization signal for defining a driving period, a field synchronization signal for defining a plurality of fields in the driving period, and a plurality of gamma voltages each related to a corresponding field in the driving period. Next, a plurality of control signals are outputted according to the vertical synchronization signal and the field synchronization signal. In a specific field, a corresponding gamma voltage among the plurality of gamma voltages is outputted according to the plurality of control signals.

### BACKGROUND OF THE INVENTION

1. Field of the Invention

The present invention is related to an LCD device, and more particularly, to an LCD device capable of reducing color distortion.

2. Description of the Prior Art

Liquid crystal display (LCD) devices, characterized in low radiation, thin appearance and low power consumption, have gradually replace traditional cathode ray tube (CRT) displays and been widely used in various electronic products such as notebook computers, personal digital assistants (PDAs), flat panel TVs or mobile phones. There are two common types of LCD device: color filter LCD devices and color sequential LCD device. A color filter LCD device displays images based on spatial color distribution in human perception. For example, in a thin film transistor liquid crystal display (TFT-LCD) device, each individual display pixel is divided into three sub-pixels which are colored red, green, and blue, respectively by additional color filters. Each sub-pixel can be controlled independently to yield thousands or millions of possible colors for each pixel, thereby providing full-color images.

In a color sequential LCD device, a tri-color backlighting is adopted to emit red, green and blue light in a predetermined sequence with one color at a time as required by the display content of each pixel. The timing controller of the color sequential LCD device needs to be synchronized with the backlight so that when a given color backlight is on, only the matching color sub-pixels in the color sequential LCD device are turned on for receiving a respective single-color frame. In other words, a color sequential LCD device displays full-color images based on temporal color distribution in human perception as a result of the persistence of vision. Compared to the color filter LCD device, the color sequential LCD device does not require a color filter, therefore is advantageous in cost saving, down-sizing and high light transmittance.

FIG. 1 is a diagram illustrating a prior art color sequential LCD device 100. The color sequential LCD device 100 includes an LCD panel 110, a source driver 120, a gate driver 130, a timing controller 140, and a gamma output circuit 150. The timing controller 140 is configured to generate an original image data signal DATA and a start pulse signal VST. The gamma output circuit 150 is configured to output a constant gamma voltage γ to the source driver 120. Therefore, the gate driver 130 can selectively turn on the pixels of the LCD panel 110 according to the start pulse signal VST, while the source driver 120 can write data into the pixels of the LCD panel 110 according to the original image data signal DATA and the gamma voltage γ. However, the prior art color sequential LCD device 100 provides full-color images by adjusting the three primary colors based on the constant gamma voltage γ. Since the transmittance of each color is related to the state of liquid crystal material, the overall brightness of the three primary colors is not necessarily equal to that of the white color, which may in turn cause color distortion.

FIG. 2 is a gamma chart illustrating the relationship between light transmittance and pixel gray scale when a color sequential LCD device displays a white image and a red/green/blue mixed image. In FIG. 2, a curve W represents the brightness when the color sequential LCD device displays a white image, while a curve W′ represents the overall brightness when the color sequential LCD device displays a red/green/blue mixed image. As depicted in FIG. 2, the difference between curves W and W′ increases with the gray scale of the pixel. For example, when the gray scale of the pixel is equal to 255, the overall brightness of the red/green/blue mixed image is only 63% of the brightness of the white image displayed on the color sequential LCD device, thereby largely influencing display quality.

FIG. 3 is a diagram illustrating the CIE color chart of a color filter LCD device, and FIG. 4 is a diagram illustrating the CIE color chart of a color sequential LCD device. CIE chart is a color coordinate system specified by Commission Internationale de l'clairage, in which trichromatic coefficients ER, EG and EB are used for representing the percentages of red, green and blue colors in a displayed image of a pixel. Since the sum of the three trichromatic coefficients ER, EG and EB is equal to 1, a color space formed by the three primary colors can be represented by the horizontal axis of ER and the vertical axis of EG in the CIE color chart. In the CIE color chart, the three primary colors of red, green and blue are located at the three apexes which indicates highest chroma, while the white color is located at the center which indicates lowest chroma. During normal image processing, images of different tones are provided by simultaneously adjusting the three primary colors based on a specific gamma voltage. In FIGS. 3 and 4, curves C, M, Y respectively represent cyan (blue/green mixed), magenta (red/blue mixed) and yellow (red/green mixed) colors in a color filter LCD device, while curves C′, M′, Y′ respectively represent cyan, magenta and yellow colors in a color sequential LCD device. As depicted in FIG. 3, the curves C, M, Y in a color filter LCD device have a desirable linear distribution, but the curves C′, M′, Y′ in a color sequential LCD device have a undesirable non-linear distribution, which may cause color distortion.

### SUMMARY OF THE INVENTION

The present invention provides a color sequential LCD device comprising a timing controller configured to provide a vertical synchronization signal and a field synchronization signal, wherein the vertical synchronization signal defines when a driving period of the color sequential liquid crystal device starts and the field synchronization signal defines a plurality of fields in the driving period of the color sequential liquid crystal device; a gamma select unit configured to output a plurality of control signals according to the vertical synchronization signal and the field synchronization signal; an adjustable gamma output circuit configured to store a plurality of gamma voltages and output a corresponding gamma voltage among the plurality of Gamma voltages during a specific field according to the plurality of control signals; and a source diver configured to output an image data signal according to the corresponding gamma voltage received from the adjustable gamma output circuit.

The present invention further provides a method for driving a color sequential LCD device and comprising providing a vertical synchronization signal for defining when a driving period of the color sequential liquid crystal device starts; providing a field synchronization signal for defining a plurality of fields in the driving period of the color sequential liquid crystal device; providing a plurality of gamma voltages; outputting a plurality of control signals according to the vertical synchronization signal and the field synchronization signal; and outputting a corresponding gamma voltage among the plurality of gamma voltages during a specific field according to the plurality of control signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art color sequential LCD device.

FIG. 2 is a gamma chart illustrating the relationship between light transmittance and pixel gray scale when a color sequential LCD device displays a white image and a red/green/blue mixed image.

FIG. 3 is a diagram illustrating the CIE color chart of a color filter LCD device.

FIG. 4 is a diagram illustrating the CIE color chart of a color sequential LCD device.

FIG. 5 is a diagram illustrating a color sequential LCD device according to the present invention.

FIGS. 6 and 7 are timing diagrams illustrating methods for driving a color sequential LCD device according to the embodiments of the present invention.

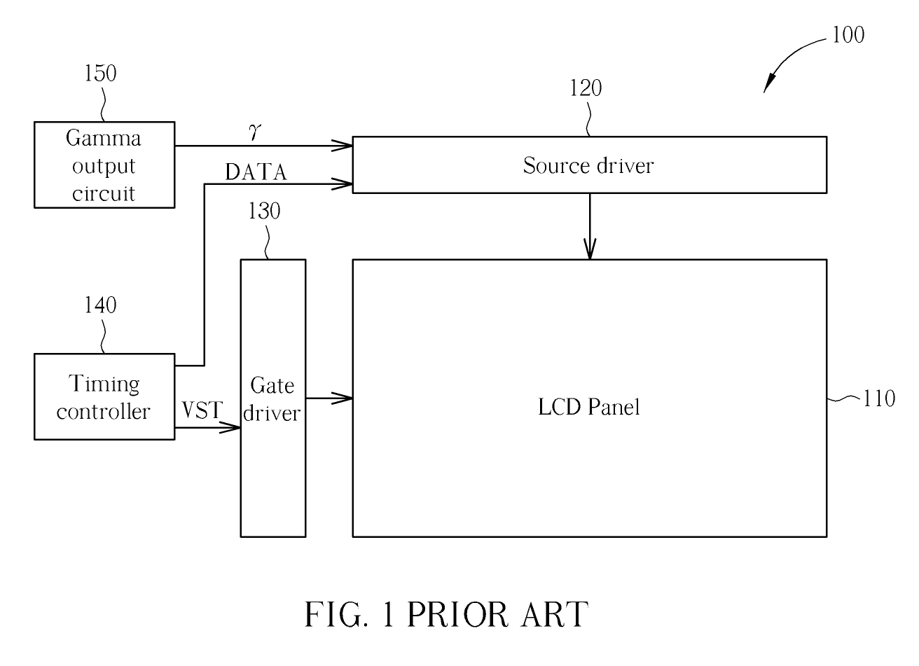

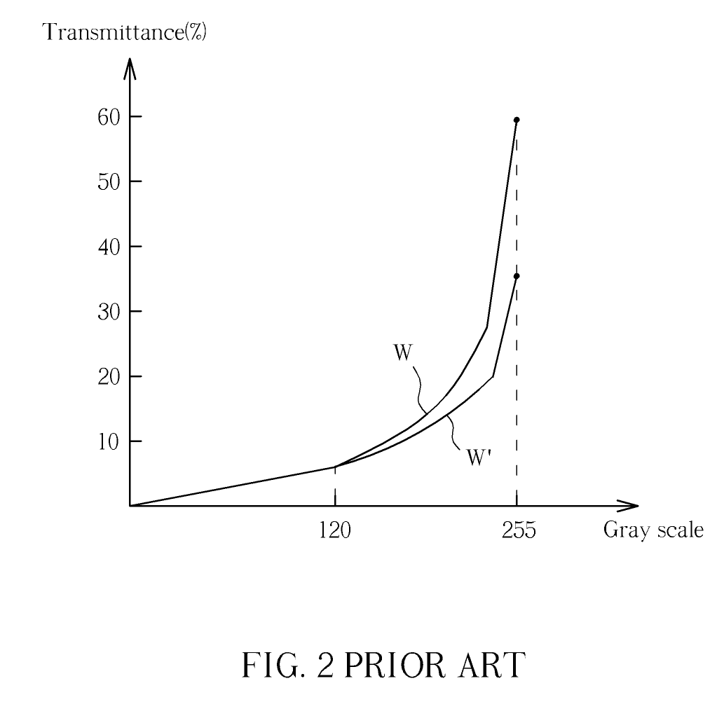

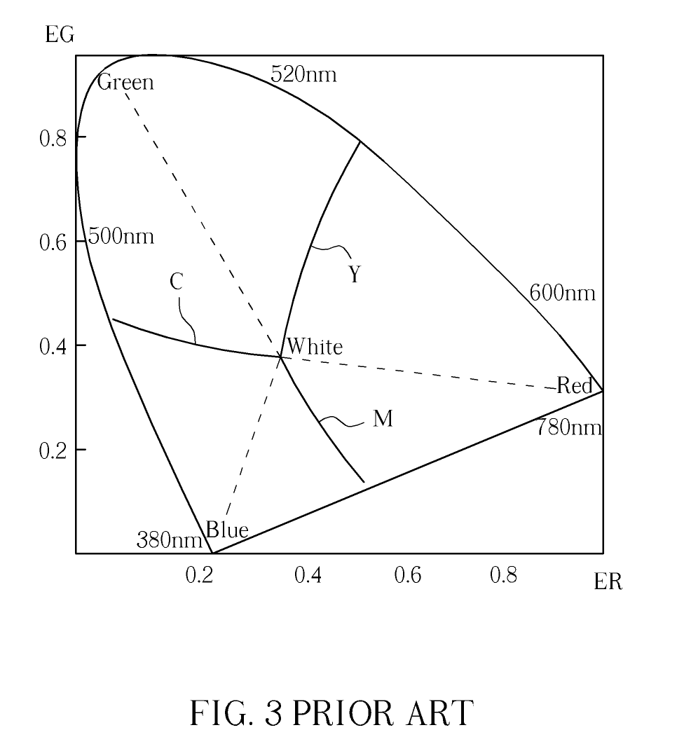

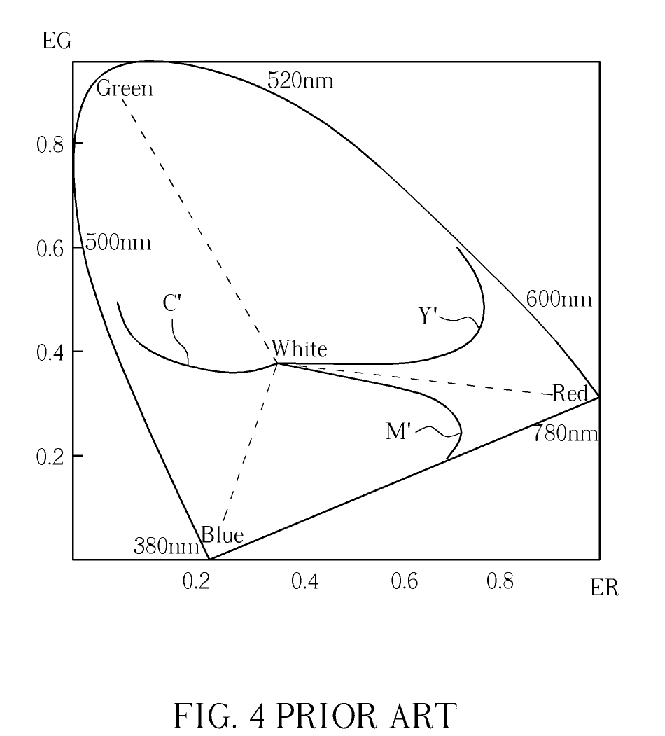

### DETAILED DESCRIPTION

Certain terms are used throughout the following description and claims to refer to particular components. As one skilled in the art will appreciate, manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. Also, the term “couple” is intended to mean either a direct or an indirect electrical connection. Accordingly, if one device is coupled to another device, the electrical connection maybe through a direct electrical connection, or through an indirect electrical connection via other devices and connections.

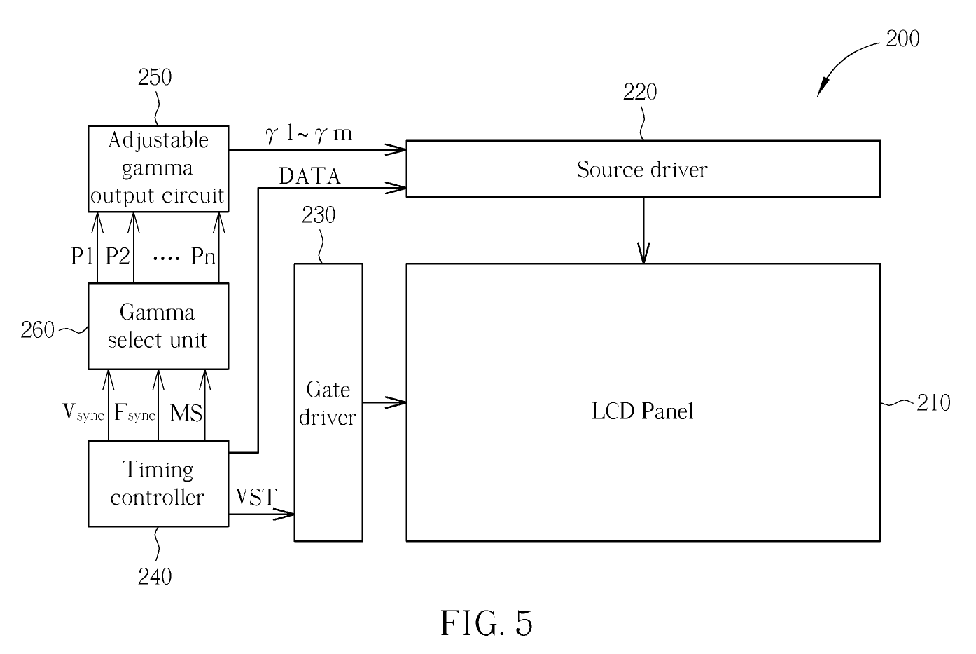

FIG. 5 is a diagram illustrating a color sequential LCD device 200 according to the present invention. The color sequential LCD device 200 includes an LCD panel 210, a source driver 220, a gate driver 230, a timing controller 240, an adjustable gamma output circuit 250 and a gamma select unit 260. A plurality of pixels are disposed on the LCD panel 210. The timing controller 240 is configured to generate an original image data signal DATA, a start pulse signal VST, a vertical synchronization signal Vsync, a field synchronization signal Fsync, and a mode select signal MS. The vertical synchronization signal Vsync defines when a driving period of the color sequential LCD device 200 starts, the field synchronization signal Fsync defines the frames in the driving period of the color sequential LCD device 200, and the mode select signal MS is for selecting among a plurality of operation modes supported by the color sequential LCD device 200 (the mode select signal MS is not required if the color sequential LCD device 200 only supports a single operation mode). The gamma select unit 260 is configured to output n control signals P1-Pn to the gamma output circuit 250 according to the vertical synchronization signal Vsync, the field synchronization signal Fsync and the mode select signal MS. The adjustable gamma output circuit 250 is configured to store a plurality of gamma voltages γ1-γm and output a corresponding gamma voltage to the source driver 220 according to the levels of the control signals P1-Pn. Therefore, the gate driver 230 can generate the gate driving signals for turning on the pixels of the LCD panel 210 according to the start pulse signal VST, while the source driver 220 can write data into the pixels of the LCD panel 210 according to the original image data signal DATA and the gamma voltage received from the adjustable gamma output circuit 250.

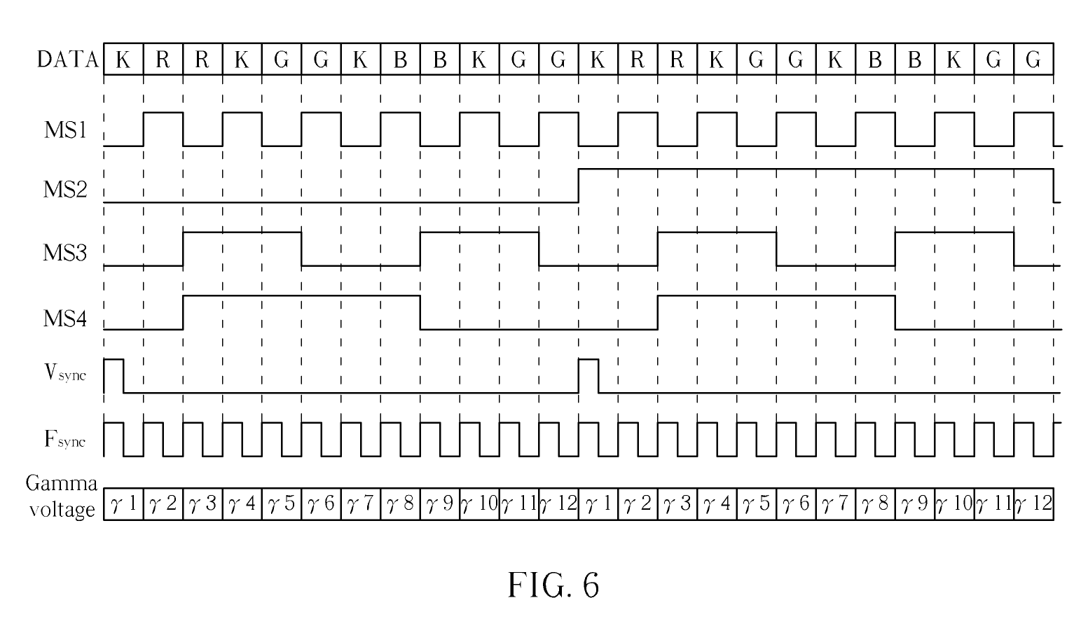

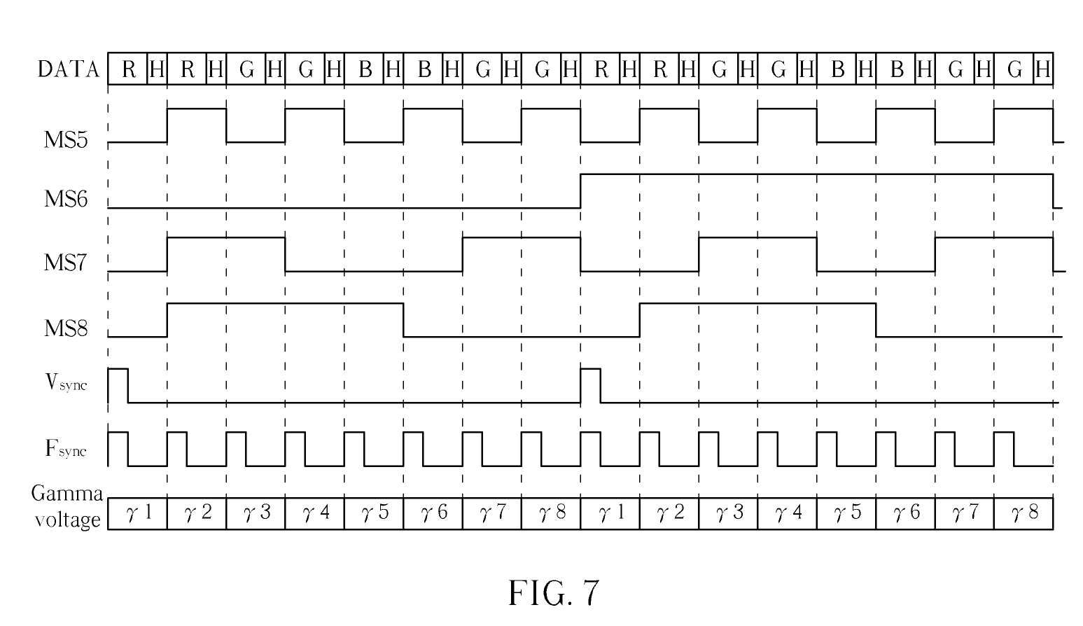

FIGS. 6 and 7 are timing diagrams illustrating methods for driving the color sequential LCD device 200 according to the embodiments of the present invention. In FIGS. 6 and 7, the color sequential LCD device 200 supports 8 operation modes, whose corresponding mode select signals are represented by MS1-MS8. In the first to fourth operation modes as depicted in FIG. 6, the original image data signal DATA includes continuous data in which R represents red image data, G represents green image data, B represents blue image data, and K represents black image data. If the frequency of the vertical synchronization signal Vsync is 60 Hz and the frequency of the field synchronization signal Fsync is 720 Hz, then a driving period includes 12 fields. According to the mode select signals MS1-MS4, the fields of different colors can be outputted in a predetermined manner so as to provide full-color images based on the persistence of vision in human perception.

In the first driving mode, the operations performed during the 12 fields of each driving period sequentially includes: outputting negative black image data, outputting positive red image data, outputting negative red image data, outputting positive black image data, outputting negative green image data, outputting positive green image data, outputting negative black image data, outputting positive blue image data, outputting negative blue image data, outputting positive black image data, outputting negative green image data, and outputting positive green image data.

In the second driving mode, the operations performed during the 12 fields of each odd-numbered driving period sequentially includes: outputting negative black image data, outputting negative red image data, outputting negative red image data, outputting negative black image data, outputting negative green image data, outputting negative green image data, outputting negative black image data, outputting negative blue image data, outputting negative blue image data, outputting negative black image data, outputting negative green image data, and outputting negative green image data, while the operations performed during the 12 fields of each even-numbered driving period sequentially includes: outputting positive black image data, outputting positive red image data, outputting positive red image data, outputting positive black image data, outputting positive green image data, outputting positive green image data, outputting positive black image data, outputting positive blue image data, outputting positive blue image data, outputting positive black image data, outputting positive green image data, and outputting positive green image data.

In the third driving mode, the operations performed during the 12 fields of each driving period sequentially includes: outputting negative black image data, outputting negative red image data, outputting positive red image data, outputting positive black image data, outputting positive green image data, outputting negative green image data, outputting negative black image data, outputting negative blue image data, outputting positive blue image data, outputting positive black image data, outputting positive green image data, and outputting negative green image data.

In the fourth driving mode, the operations performed during the 12 fields of each driving period sequentially includes: outputting negative black image data, outputting negative red image data, outputting positive red image data, outputting positive black image data, outputting positive green image data, outputting positive green image data, outputting positive black image data, outputting positive blue image data, outputting negative blue image data, outputting negative black image data, outputting negative green image data, and outputting negative green image data.

In the fifth to fourth operation modes as depicted in FIG. 7, the original image data signal DATA includes discontinuous data in which R represents red image data, G represents green image data, B represents blue image data, and H represents no data output. If the frequency of the vertical synchronization signal Vsync is 60 Hz and the frequency of the field synchronization signal Fsync is 480 Hz, then a driving period includes 8 fields. According to the mode select signals MS5-MS8, the fields of different colors can be outputted in a predetermined manner so as to provide full-color images based on the persistence of vision in human perception.

In the fifth driving mode, the operations performed during the 8 fields of each driving period sequentially includes: outputting negative red image data, outputting positive red image data, outputting negative green image data, outputting positive green image data, outputting negative blue image data, outputting positive blue image data, outputting negative green image data, and outputting positive green image data.

In the sixth driving mode, the operations performed during the 8 fields of each odd-numbered driving period sequentially includes: outputting negative red image data, outputting negative red image data, outputting negative green image data, outputting negative green image data, outputting negative blue image data, outputting negative blue image data, outputting negative green image data, and outputting negative green image data, while the operations performed during the 8 fields of each even-numbered driving period sequentially includes: outputting positive red image data, outputting positive red image data, outputting positive green image data, outputting positive green image data, outputting positive blue image data, outputting positive blue image data, outputting positive green image data, and outputting positive green image data.

In the seventh driving mode, the operations performed during the 8 fields of each driving period sequentially includes: outputting negative red image data, outputting positive red image data, outputting positive green image data, outputting negative green image data, outputting negative blue image data, outputting negative blue image data, outputting positive green image data, and outputting positive green image data.

In the eight driving mode, the operations performed during the 8 fields of each driving period sequentially includes: outputting negative red image data, outputting positive red image data, outputting positive green image data, outputting positive green image data, outputting positive blue image data, outputting negative blue image data, outputting negative green image data, and outputting negative green image data.

The present invention provides different gamma voltages according to operation modes. For the 12 fields in the first to fourth operation modes, the adjustable gamma output circuit 250 is configured to store 12built-in gamma voltages γ1˜γ12, and the gamma select unit 260 is configured to output at least 4 control signals P1-P4. When both the vertical synchronization signal Vsync and the field synchronization signal Fsync are at high level, the gamma select unit 260 resets the value of its built-in register to zero; when the vertical synchronization signal Vsync is at low level and the field synchronization signal Fsync is at high level, the gamma select unit 260 increases the value of its built-in register by 1. When the logic levels (P1, P2, P3, P4) of the control signals outputted by the gamma select unit 260 are (0,0,0,0), the gamma output circuit 250 outputs the gamma voltage γ1; when the logic levels (P1, P2, P3, P4) of the control signals outputted by the gamma select unit 260 are (0,0,0,1), the gamma output circuit 250 outputs the gamma voltage γ2; . . . ; when the logic levels (P1, P2, P3, P4) of the control signals outputted by the gamma select unit 260 are (1,1,0,0), the gamma output circuit 250 outputs the gamma voltage γ12. Therefore, each field in the first to fourth operation modes has a corresponding gamma voltage.

For the 8 fields in the fifth to eighth operation modes, the adjustable gamma output circuit 250 is configured to store 8 built-in gamma voltages γ1˜γ8, and the gamma select unit 260 is configured to output at least 3 control signals P1-P3. When both the vertical synchronization signal Vsync and the field synchronization signal Fsync are at high level, the gamma select unit 260 resets the value of its built-in register to zero; when the vertical synchronization signal Vsync is at low level and the field synchronization signal Fsync is at high level, the gamma select unit 260 increases the value of its built-in register by 1. When the logic levels (P1, P2, P3) of the control signals outputted by the gamma select unit 260 are (0,0,0), the gamma output circuit 250 outputs the gamma voltage γ1; when the logic levels (P1, P2, P3) of the control signals outputted by the gamma select unit 260 are (0,0,1), the gamma output circuit 250 outputs the gamma voltage γ2; . . . ; when the logic levels (P1, P2, P3, P4) of the control signals outputted by the gamma select unit 260 are (1,1,1), the gamma output circuit 250 outputs the gamma voltage γ8. Therefore, each field in the fifth to eighth operation modes has a corresponding gamma voltage.

In the present invention, different gamma voltages are provided for different operation modes so that each field can have a corresponding gamma voltage. Different degrees of gamma correction can thus be performed on the three primary colors so that the liquid crystal molecules are identically tilted when displaying the three primary colors in order to improve color distortion.

Those skilled in the art will readily observe that numerous modifications and alterations of the device and method may be made while retaining the teachings of the invention.

What is claimed is:

1. A color sequential liquid crystal display (LCD) device comprising:
a timing controller configured to provide a vertical synchronization signal and a field synchronization signal, wherein the vertical synchronization signal defines when a driving period of the color sequential liquid crystal device starts and the field synchronization signal defines a plurality of fields in the driving period of the color sequential liquid crystal device;
a gamma select unit configured to output a plurality of control signals according to the vertical synchronization signal and the field synchronization signal;
an adjustable gamma output circuit configured to store a plurality of gamma voltages and output a corresponding gamma voltage among the plurality of Gamma voltages during a specific field according to the plurality of control signals; and
a source diver configured to output an image data signal according to the corresponding gamma voltage received from the adjustable gamma output circuit.

2. The color sequential LCD device of claim 1 wherein:
the timing controller further provides a mode select signal for selecting one of a plurality of operation modes supported by the color sequential LCD device; and
the gamma select unit further outputs the plurality of control signals according to the mode select signal.

3. The color sequential LCD device of claim 1 further comprising an LCD panel having a plurality of pixels and configured to display images according to the image data signal received from the source driver.

4. The color sequential LCD device of claim 3 further comprising a gate driver configured to generate gate driving signals for turning on the plurality of pixels.

5. The color sequential LCD device of claim 1 wherein the gamma select unit includes a register and is configured to update a value of the register according to the vertical synchronization signal and the field synchronization signal, and set levels of the plurality of the control signals according to the value of the register.

6. A method for driving a color sequential LCD device, comprising:
providing a vertical synchronization signal for defining when a driving period of the color sequential liquid crystal device starts;
providing a field synchronization signal for defining a plurality of fields in the driving period of the color sequential liquid crystal device;
providing a plurality of gamma voltages;
outputting a plurality of control signals according to the vertical synchronization signal and the field synchronization signal; and
outputting a corresponding gamma voltage among the plurality of gamma voltages during a specific field according to the plurality of control signals.

7. The method of claim 6 further comprising:
outputting the image data signal according to the corresponding gamma voltage.

8. The method of claim 6 further comprising:
providing a mode select signal for selecting one of a plurality of operation modes supported by the color sequential LCD device; and
outputting the plurality of control signals according to the vertical synchronization signal, the field synchronization signal and the mode select signal.

9. The method of claim 6 further comprising:
providing the plurality of gamma voltages corresponding to each field in the driving period of the color sequential LCD device.

10. The method of claim 6 wherein outputting the plurality of control signals according to the vertical synchronization signal and the field synchronization signal comprises:
setting a value of a register to zero when the vertical synchronization signal and the field synchronization signal are both at a first level;
increasing the value of the register by 1 when the vertical synchronization signal is at a second level and the field synchronization signal is at the first level; and
setting levels of the plurality of control signals according to the value of the register.

11. The method of claim 10 wherein the first level is logic 1 and the second level is logic 0.
